(19) United States
(12) Patent Application Publication
(10) Pub. No.: US 2005/0136187 A1
(43) Pub. Date: Jun. 23, 2005

(54) Method of improving adhesion of a coating to a flexible graphite material

(76) Inventors: Thomas William Weber, Cleveland, OH (US); Matthew George Getz, Medina, OH (US); Lawrence K. Jones, Parma, OH (US); Jeremy Klug, Brunswick, OH (US)

Correspondence Address: WADDEY & PATTERSON, 414 UNION STREET, SUITE 2020, BANK OF AMERICA PLAZA, NASHVILLE, TN, 37219, US

(21) Appl. No.: 10/745,402

(22) Filed: Dec. 23, 2003

(51) Int. Cl. B05D 1/12

(52) U.S. Cl. 427/402; 427/180

(57) ABSTRACT

A method for improving the adhesion of a functional coating to an article formed of compressed particles of exfoliated graphite, which includes applying a primer coating to the article, where the primer coating has as its constituents at least some of the constituents of the functional coating and exhibits greater adhesion to the article than does the functional coating.

### TECHNICAL FIELD

Methods are provided for improving the adhesion of a coating to a flexible graphite material. The inventive methods are particularly useful for the manufacture of materials suitable for the formation of components for flow-through capacitors, fuel cells, such as flow field plates, gas diffusion layers, and/or electrodes and such.

### BACKGROUND OF THE ART

An ion exchange membrane fuel cell, more specifically a proton exchange membrane (PEM) fuel cell, produces electricity through the chemical reaction of hydrogen and oxygen in the air. Within the fuel cell, electrodes, denoted as anode and cathode, surround a polymer electrolyte to form what is generally referred to as a membrane electrode assembly, or MEA. Oftentimes, the electrodes also function as the gas diffusion layer (or GDL) of the fuel cell. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell includes a membrane electrode assembly sandwiched between two flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes. In operation, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which joins with the protons through the proton exchange membrane and the electrons through the circuit, and combine to form water. Since the membrane is an insulator, the electrons travel through an external circuit in which the electricity is utilized, and join with protons at the cathode. An air stream on the cathode side is one mechanism by which the water formed by combination of the hydrogen and oxygen is removed. Combinations of such fuel cells are used in a fuel cell stack to provide the desired voltage.

It has been disclosed that a graphite sheet that has been provided with channels, which are preferably smooth-sided, and which pass between the parallel, opposed surfaces of the flexible graphite sheet and are separated by walls of compressed expandable graphite, can be used to form gas diffusion layers for PEM fuel cells. As taught by Mercuri, Weber and Warddrip in U.S. Pat. No. 6,413,671, the disclosure of which is incorporated herein by reference, the channels can be formed in the flexible graphite sheet at a plurality of locations by a compressive mechanical impact, such as by use of rollers having truncated protrusions extending therefrom. The channel pattern can be devised in order to control, optimize or maximize fluid flow through the channels, as desired. For instance, the pattern formed in the flexible graphite sheet can comprise selective placement of the channels, or it can comprise variations in channel density or channel shape in order to, for instance, reduce or minimize flooding, control gas flow, restrict water flow, equalize fluid pressure along the surface of the electrode when in use, or for other purposes. See, for instance, Mercuri and Krassowski in International Publication No. WO 02/41421 A1.

Compressive force may also be used to form the continuous reactant flow channel in the material used to form a flow field plate (hereinafter “FFP”). Typically an embossing tool is used to compress the graphite sheet and emboss the channels in the sheet. Unlike, the GDL, the channel(s) in the FFP do not extend through the FFP from one opposed surface to a second surface. Typically, the channel(s) is on one surface of the FFP.

In addition, and as taught by Mercuri et al. in U.S. Pat. No. 6,528,199, the disclosure of which is incorporated herein by reference, a combination GDL/FFP can be provided, wherein a reactant flow channel is formed in a graphite sheet that has been provided with channels. Therefore, both the fluid flow function of an FFP and the fluid diffusion function of a GDL can be combined in a single component.

Depending on the desired end use of the flexible graphite sheet, whether it be flow field plate, gas diffusion layer, catalyst support, or a non-fuel cell application such as heat sinks, heat spreaders or thermal interfaces for electronic thermal management applications, it may be necessary to provide a functional coating on the sheet. Different coatings which have been employed include hydrophobic coatings to increase the hydrophobicity of the graphite material (see, for instance, U.S. Pat. No. 6,605,379 to Mercuri and Krassowski), protective coatings to electrically isolate the graphite material or prevent flaking of the graphite material (see, for instance, Tzeng and Krassowski in International Publication No. WO 02/082535), etc. However, adhesion of coatings to a flexible graphite material has been found to be problematic. Delamination or separation of the coating from the graphite is common. Although the use of certain primer coatings has been suggested for certain applications, such as in U.S. Pat. No. 6,245,400 to Tzeng, such primer coatings may not be desirable where they interfere with or dilute the functionality of the coating or coated sheet. For example, a non-thermally conductive primer coating can reduce the thermal advantages of a thermal interface, heat sink or heat spreader.

What is desired, therefore, is a method of improving the adhesion of a functional coating to a flexible graphite material. The desired method should reduce the tendency of known coatings to delaminate or otherwise separate from the graphite as well as facilitate the use of coatings for flexible graphite materials otherwise thought impractical because of poor adhesion. In addition, the method should improve the adhesion of a coating to a flexible graphite material without substantially degrading performance.

Graphites are made up of layered planes of hexagonal arrays or networks of carbon atoms. These layered planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional, e.g., thermal and electrical conductivity and fluid diffusion.

Graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van der Waals forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been greatly expanded and more particularly expanded so as to have a final thickness or “c” direction dimension which is as much as about 80 or more times the original “c” direction dimension can be formed without the use of a binder into cohesive or integrated sheets of expanded graphite, e.g. webs, papers, strips, tapes, foils, mats or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles. These flexible graphite sheets can be described as sheets of compressed particles of exfoliated graphite.

In addition to flexibility, the sheet material, as noted above, has also been found to possess a high degree of anisotropy with respect to thermal and electrical conductivity and fluid diffusion, comparable to the natural graphite starting material due to orientation of the expanded graphite particles and graphite layers substantially parallel to the opposed faces of the sheet resulting from very high compression, e.g. roll pressing. Sheet material thus produced has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cc to about 2.0 g/cc. The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increased density. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal and electrical properties of the sheet are very different, by orders of magnitude, for the “c” and “a” directions.

### SUMMARY OF THE INVENTION

One aspect of the invention is a method of improving the adhesion of a functional coating to a flexible graphite sheet. The method includes the step of applying a primer coating to the sheet, where the primer coating is formed using at least one of the constituents of the functional coating, but which exhibits greater adhesion to a flexible graphite sheet than the functional coating does. For instance, the primer coating can be formed from the functional coating diluted so as to have a reduced viscosity. The functional coating in the desired viscosity is then applied to the primer-coated flexible graphite sheet.

Another aspect of the invention is to apply a primer coating formed from one or more of the constituents of the functional coating, where the primer coating is applied to the flexible graphite sheet before the sheet is compressed to its final density. In other words, if a coated sheet having a density of about 1.5 g/cc is desired, the primer coating is applied when the sheet density is less than 1.5 g/cc, such as when the sheet is in mat form with a density of about 0.9 g/cc or less. The primer-coated sheet is then compressed to the desired density, after which it is coated with the functional coating.

A further aspect of the invention involves impregnating a primer coating into the surface of the flexible graphite sheet, after which the functional coating is applied. The impregnated primer coating adheres well to the sheet because it extends in to the internal structure of the sheet, and the functional coating adheres well to the primer coating, and, therefore, to the sheet.

In yet another aspect of the invention, the coated sheets can be employed in the formation of components for a PEM fuel cell, including a gas diffusion layer and/or a flow field plate, and in the formation of electronic thermal management components, such as a heat sink, a heat spreader and/or a thermal interface. In addition, the embossed sheets can also be used to form components for a flow-through capacitor, as described by Calarco et al. in U.S. Pat. No. 6,410,128.

It is to be understood that both the foregoing general description and the following detailed description present embodiments of the invention, and are intended to provide an overview or framework for understanding the nature and character of the invention as it is claimed.

### DETAILED DESCRIPTION OF THE INVENTION

The methods of the present invention relate to improving the adhesion of coatings to flexible graphite sheets. Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials for the flexible sheets suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials for the flexible sheets used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than twenty weight percent. More preferably, the graphite employed for the present invention will have a purity of at least about 94%. In the most preferred embodiment, such as for fuel cell applications, the graphite employed will have a purity of at least about 99%.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine as a solution of bromine and sulfuric acid or bromine in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 125° C. to promote reaction of the reducing agent and intercalant coating. The heating period is up to about 2 hours, with shorter heating periods, e.g., at least about 10 minutes, for higher temperatures in the above-noted range. Times of one-half hour or less, e.g., on the order of 10 to 25 minutes, can be employed at the higher temperatures.

The above described methods for intercalating and exfoliating graphite flake may beneficially be augmented by a pretreatment of the graphite flake at graphitization temperatures, i.e. temperatures in the range of about 3000° C. and above and by the inclusion in the intercalant of a lubricious additive.

The pretreatment, or annealing, of the graphite flake results in significantly increased expansion (i.e., increase in expansion volume of up to 300% or greater) when the flake is subsequently subjected to intercalation and exfoliation. Indeed, desirably, the increase in expansion is at least about 50%, as compared to similar processing without the annealing step. The temperatures employed for the annealing step should not be significantly below 3000° C., because temperatures even 100° C. lower result in substantially reduced expansion.

The annealing of the present invention is performed for a period of time sufficient to result in a flake having an enhanced degree of expansion upon intercalation and subsequent exfoliation. Typically the time required will be 1 hour or more, preferably 1 to 3 hours and will most advantageously proceed in an inert environment. For maximum beneficial results, the annealed graphite flake will also be subjected to other processes known in the art to enhance the degree expansion—namely intercalation in the presence of an organic reducing agent, an intercalation aid such as an organic acid, and a surfactant wash following intercalation. Moreover, for maximum beneficial results, the intercalation step may be repeated.

The annealing step of the instant invention may be performed in an induction furnace or other such apparatus as is known and appreciated in the art of graphitization; for the temperatures here employed, which are in the range of 3000° C., are at the high end of the range encountered in graphitization processes.

Because it has been observed that the worms produced using graphite subjected to pre-intercalation annealing can sometimes “clump” together, which can negatively impact area weight uniformity, an additive that assists in the formation of “free flowing” worms is highly desirable. The addition of a lubricious additive to the intercalation solution facilitates the more uniform distribution of the worms across the bed of a compression apparatus (such as the bed of a calender station conventionally used for compressing, or “calendering,” graphite worms into flexible graphite sheet). The resulting sheet therefore has higher area weight uniformity and greater tensile strength. The lubricious additive is preferably a long chain hydrocarbon, more preferably a hydrocarbon having at least about 10 carbons. Other organic compounds having long chain hydrocarbon groups, even if other functional groups are present, can also be employed.

More preferably, the lubricious additive is an oil, with a mineral oil being most preferred, especially considering the fact that mineral oils are less prone to rancidity and odors, which can be an important consideration for long term storage. It will be noted that certain of the expansion aids detailed above also meet the definition of a lubricious additive. When these materials are used as the expansion aid, it may not be necessary to include a separate lubricious additive in the intercalant.

The lubricious additive is present in the intercalant in an amount of at least about 1.4 pph, more preferably at least about 1.8 pph. Although the upper limit of the inclusion of lubricous additive is not as critical as the lower limit, there does not appear to be any significant additional advantage to including the lubricious additive at a level of greater than about 4 pph.

The thus treated particles of graphite are sometimes referred to as “particles of intercalated graphite.” Upon exposure to high temperature, e.g. temperatures of at least about 160° C. and especially about 700° C. to 1200° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.075 mm to 3.75 mm and a typical density of about 0.1 to 1.5 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

The flexible graphite sheet can also, at times, be advantageously treated with resin and the absorbed resin, after curing, enhances the moisture resistance and handling strength, i.e. stiffness, of the flexible graphite sheet as well as “fixing” the morphology of the sheet. Suitable resin content is preferably at least about 5% by weight, more preferably about 10 to 35% by weight, and suitably up to about 60% by weight. Resins found especially useful in the practice of the present invention include acrylic-, epoxy- and phenolic-based resin systems, fluoro-based polymers, or mixtures thereof. Suitable epoxy resin systems include those based on diglycidyl ether of bisphenol A (DGEBA) and other multifunctional resin systems; phenolic resins that can be employed include resole and novolac phenolics. Optionally, the flexible graphite may be impregnated with fibers and/or salts in addition to the resin or in place of the resin. Additionally, reactive or non-reactive additives may be employed with the resin system to modify properties (such as tack, material flow, hydrophobicity, etc.).

Alternatively, the flexible graphite sheets of the present invention may utilize particles of reground flexible graphite sheets rather than freshly expanded worms. The sheets may be newly formed sheet material, recycled sheet material, scrap sheet material, or any other suitable source.

Also the processes of the present invention may use a blend of virgin materials and recycled materials.

The source material for recycled materials may be sheets or trimmed portions of sheets that have been compression molded as described above, or sheets that have been compressed with, for example, pre-calendering rolls, but have not yet been impregnated with resin. Furthermore, the source material may be sheets or trimmed portions of sheets that have been impregnated with resin, but not yet cured, or sheets or trimmed portions of sheets that have been impregnated with resin and cured. The source material may also be recycled flexible graphite PEM fuel cell components such as flow field plates or electrodes. Each of the various sources of graphite may be used as is or blended with natural graphite flakes.

Once the source material of flexible graphite sheets is available, it can then be comminuted by known processes or devices, such as a jet mill, air mill, blender, etc. to produce particles. Preferably, a majority of the particles have a diameter such that they will pass through 20 U.S. mesh; more preferably a major portion (greater than about 20%, most preferably greater than about 50%) will not pass through 80 U.S. mesh. Most preferably the particles have a particle size of no greater than about 20 mesh. It may be desirable to cool the flexible graphite sheet when it is resin-impregnated as it is being comminuted to avoid heat damage to the resin system during the comminution process.

The size of the comminuted particles may be chosen so as to balance machinability and formability of the graphite article with the thermal characteristics desired. Thus, smaller particles will result in a graphite article which is easier to machine and/or form, whereas larger particles will result in a graphite article having higher anisotropy, and, therefore, greater in-plane electrical and thermal conductivity.

If the source material has been resin impregnated, then preferably the resin is removed from the particles. Details of the resin removal are further described below.

Once the source material is comminuted, and any resin is removed, it is then re-expanded. The re-expansion may occur by using the intercalation and exfoliation process described above and those described in U.S. Pat. No. 3,404,061 to Shane et al. and U.S. Pat. No. 4,895,713 to Greinke et al.

Typically, after intercalation the particles are exfoliated by heating the intercalated particles in a furnace. During this exfoliation step, intercalated natural graphite flakes may be added to the recycled intercalated particles. Preferably, during the re-expansion step the particles are expanded to have a specific volume in the range of at least about 100 cc/g and up to about 350 cc/g or greater. Finally, after the re-expansion step, the re-expanded particles may be compressed into flexible sheets, as hereinafter described.

If the starting material has been impregnated with a resin, the resin should preferably be at least partially removed from the particles. This removal step should occur between the comminuting step and the re-expanding step.

In one embodiment, the removing step includes heating the resin containing regrind particles, such as over an open flame. More specifically, the impregnated resin may be heated to a temperature of at least about 250° C. to effect resin removal. During this heating step care should be taken to avoid flashing of the resin decomposition products; this can be done by careful heating in air or by heating in an inert atmosphere. Preferably, the heating should be in the range of from about 400° C. to about 800° C. for a time in the range of from at least about 10 and up to about 150 minutes or longer.

Additionally, the resin removal step may result in increased tensile strength of the resulting article produced from the molding process as compared to a similar method in which the resin is not removed. The resin removal step may also be advantageous because during the expansion step (i.e., intercalation and exfoliation), when the resin is mixed with the intercalation chemicals, it may in certain instances create toxic byproducts.

Thus, by removing the resin before the expansion step a superior product is obtained such as the increased strength characteristics discussed above. The increased strength characteristics are a result of in part because of increased expansion. With the resin present in the particles, expansion may be restricted.

In addition to strength characteristics and environmental concerns, resin may be removed prior to intercalation in view of concerns about the resin possibly creating a run away exothermic reaction with the acid.

In view of the above, preferably a majority of the resin is removed. More preferably, greater than about 75% of the resin is removed. Most preferably, greater than 99% of the resin is removed.

Once the flexible graphite sheet is comminuted, it is formed into the desired shape and then cured (when resin impregnated) in the preferred embodiment. Alternatively, the sheet can be cured prior to being comminuted, although post-comminution cure is preferred.

As noted above, the inventive method can be employed to facilitate or improve the adhesion of a functional coating to a flexible graphite material. By “functional coating” is meant a coating which alters a characteristic of the flexible graphite substrate or otherwise enhances an existing characteristic of the substrate or produces a new characteristic. For instance, a hydrophobic coating of a fluoropolymer increases the hydrophobicity of a flexible graphite sheet as compared to an uncoated sheet and thus is a functional coating. Likewise, a coating which electrically isolates a flexible graphite sheet from a material or device against which it abuts is a functional coating. Other examples of functional coatings would be apparent to the skilled artisan.

In order to improve the adhesion of such functional coatings to a flexible graphite substrate, like a sheet, the method of the present invention can be employed.

In a first embodiment, the invention contemplates applying a primer coating to the substrate. The primer coating comprises constituents of the functional coating, but where the primer coating exhibits greater adhesion to the flexible graphite substrate than does the functional coating, such as by adjusting viscosity, solids content, etc. It will be recognized that if the diluent is the common constituent between the functional coating and the primer coating, the finished article may not have measurable quantities of the common component since the diluent is often evaporated or vaporized away during processing, such as drying. Also, in the event more than one functional coating is to be applied, constituents of each functional coating can be incorporated into the primer coating for optimized effectiveness.

In a preferred embodiment of the invention, the primer coating constitutes a diluted form of the functional coating. In other words, if the functional coating consists of a perfluorinated polymer, like polytetrafluoroethylene, or styrene impregnants such as trifluorostyrene and substituted trifluorostyrenes, applied as a 20% dispersion, the primer coating can comprise a 10% dispersion of the perfluorinated polymer or styrene impregnant. The same holds true for functional coatings comprising thermoplastics and the like for isolating and/or sealing flexible graphite articles. The key to this embodiment is to employ a primer coating having a reduced viscosity as compared to the functional coating; most preferably the viscosity of the primer coating is no greater than about 75% of the viscosity of the functional coating. More preferably, the viscosity of the primer coating is no greater than about 50% of that of the functional coating.

Preferably, the viscosity of the functional coating is reduced to create the primer coating by increasing the diluent used in the functional coating. For instance, where the functional coating diluent is a solvent such as acetone, the primer coating is formed by adding sufficient amount of acetone to reduce the viscosity by the desired amount. Alternatively, a different diluent can be employed to form the primer coating.

The primer coating is then applied to the flexible graphite substrate, such as by spraying or dipping, at a sufficient level to at least partially impregnate the primer coating into the flexible graphite. Since the primer coating (due to its lower viscosity vis-à-vis the functional coating) impregnates the flexible graphite to a greater extent than the functional coating, the primer coating adheres to the flexible graphite to a greater extent. The functional coating can then adhere to the primer coating, and thus exhibits improved adhesion to the flexible graphite.

In another embodiment of the invention, a primer coating formed from one or more of the constituents of the functional coating is applied to the flexible graphite substrate. The primer coating can comprise a diluted (i.e., less viscous) form of the functional coating, or it can be a coating having some, but not all, of the constituents of the functional coating. The primer coating in this embodiment is applied to the flexible graphite substrate before the substrate is compressed to its final density. Thus, if a flexible graphite sheet having a density of about 1.5 g/cc is desired, the primer coating is applied when the sheet density is less than 1.5 g/cc, such as when the sheet is in mat form with a density of about 0.9 g/cc or less. The primer-coated sheet is then compressed to the desired density. In so doing, the primer coating is more fixedly adhered to the sheet than if simply coated on the surface of the sheet. Once the sheet is compressed, with primer coating present, the densified sheet is then coated with the functional coating.

By employing the method of the present invention, therefore, improved adhesion of coatings to flexible graphite articles is achieved. Even coatings with poor adhesion to flexible graphite can be made to adhere following the inventive method. By this means, the preparation of coated flexible graphite articles for use in forming fuel cell components, electronic thermal management devices and supercapacitors, as well as other articles, can more easily and efficiently be accomplished.

All cited patents and publications referred to in this application are incorporated by reference.

The invention thus being described, it will be obvious that it may be varied in many ways. Such variations are not to be regarded as a departure from the spirit and scope of the present invention and all such modifications as would be obvious to one skilled in the art are intended to be included within the scope of the following claims.

1. A method for improving the adhesion of a functional coating to an article formed of compressed particles of exfoliated graphite, comprising applying a primer coating to the article, the primer coating comprising at least some of the constituents of the functional coating and exhibiting greater adhesion to the article than that of the functional coating.

2. The method of claim 1 wherein the viscosity of the primer coating is less than that of the functional coating.

3. The method of claim 2 wherein the viscosity of the primer coating is no greater than about 75% of that of the functional coating.

4. The method of claim 3 wherein the viscosity of the primer coating is no greater than about 50% of that of the functional coating.

5. The method of claim 1 which further comprises coating the primer-coated article with the functional coating.

6. The method of claim 1 wherein the primer coating and the functional coating each comprise a fluoropolymer and a diluent.

7. The method of claim 6 wherein the primer coating and the functional coating have the same constituents.

8. The method of claim 7 wherein the primer coating and the functional coating differ only in the relative percentage of their constituents.

9. The method of claim 8 wherein the primer coating comprises a higher percentage of diluent than the functional coating.

10. A method for improving the adhesion of a functional coating to an article formed of compressed particles of exfoliated graphite, comprising applying a primer coating to a first article comprising compressed particles of exfoliated graphite; and thereafter compressing the primer-coated first article to a desired density.

11. The method of claim 10 wherein the density of the first article is no greater than about 0.9 g/cc.

12. The method of claim 11 wherein the desired density is at least about 1.5 g/cc.

13. The method of claim 10 wherein the viscosity of the primer coating is less than that of the functional coating.

14. The method of claim 13 wherein the viscosity of the primer coating is no greater than about 50% of that of the functional coating.

15. The method of claim 10 which further comprises coating the primer-coated article with the functional coating after compressing to the desired density.

16. The method of claim 10 wherein the primer coating and the functional coating each comprise a fluoropolymer and a diluent.

17. The method of claim 16 wherein the primer coating and the functional coating have the same constituents.

18. The method of claim 17 wherein the primer coating and the functional coating differ only in the relative percentage of their constituents.

19. The method of claim 18 wherein the primer coating comprises a higher percentage of diluent than the functional coating.
